(19) United States
(12) Patent Application Publication
(10) Pub. No.: US 2011/0134911 A1
(43) Pub. Date: Jun. 9, 2011

(54) Selective filtering for digital transmission when analogue speech has to be recreated

(75) Inventors: Mattias Nilsson, Sundbyberg (SE); Stefan Strommer, Stockholm (SE); Jan Plasberg, Stockholm (SE)

(73) Assignee: Skype Limited, Dublin (IE)

(21) Appl. No.: 12/803,278

(22) Filed: Jun. 23, 2010

(30) Foreign Application Priority Data
Dec. 8, 2009 (GB) 0921464.4

(51) Int. Cl. H04L 12/66

(52) U.S. Cl. 370/352

(57) ABSTRACT

A method, terminal and program for making a call in a packet switched network between a calling device and a called device. The method comprises receiving at a processor of the calling device samples of a speech signal and an identity of the called device, executing code on the processor to perform the steps of: determining based on the identity of the called device whether a filter should be applied to the samples, when it is determined that a filter should be applied, filtering the samples, and encoding the filtered samples for transmission on the packet switched network.

### FIELD OF THE INVENTION

The present invention relates to voice over IP communication, and in particular, but not exclusively to a method and device for making a call over a voice over IP network.

### BACKGROUND

In conventional communication systems, all telephonic devices are designed to yield a frequency response of the transfer function representing all stages from the acoustic signal to the digital signal prior to the speech encoder that matches the characteristics of the sending intermediate reference system (IRS) specified in ITU-T P.48 standard, “Specification for an Intermediate Reference System,” ITU-T Recommendation P.48, 1988. The frequency characteristics of the Intermediate Reference System according to ITU-T P.48 are shown in FIG. 1.

The frequency characteristics of the IRS provide an emphasis to the speech frequency band that is considered most important for speech intelligibility. That is, that more weight is given to the second formant frequencies rather than to the first formant, which is known to increase intelligibility of clipped speech, as discussed in I. B Thomas, “The Influence of First and Second Formants on the Intelligibility of Clipped Speech,” Journal of Audio Engineering Society, Vol. 16, No. 2, 1968.

By concentrating the energy of a narrowband signal into the second formant frequencies the intelligibility of the narrowband signal is improved, allowing improved intelligibility of a speech signal at a receiver of a call without increasing the bandwidth requirements.

Thus, conventional communication systems, for example the public switched telephone network based on fixed line and/or mobile networks, are designed to have average frequency responses as defined in the IRS specification, that emphasize the second formant frequencies.

Some communication systems allow the user of a device, such as a personal computer, to communicate across a packet-based computer network such as the Internet. Such communication systems include voice over internet protocol (“VoIP”) systems. These systems are beneficial to the user as they are often of significantly lower cost than conventional fixed line or mobile networks. This may particularly be the case for long-distance communication. To use a VoIP system, the user installs and executes client software on their device. The client software sets up the VoIP connections as well as providing other functions such as registration and authentication.

In order to be able to communicate using VoIP, the device must be capable of capturing the voice signal. Commonly, a device may be coupled to a headset, or may contain a built-in microphone that can be used for this purpose. Often, when a computer is used to place VoIP calls, the microphone or headset used will be a general purpose audio input device, and may not necessarily conform to the IRS specification of classical telephony.

When a call is made from a computer to a fixed/mobile phone using an audio input device that is not compliant with the IRS specification, the effect is that the receiving sound at the mobile or fixed phone tends to sound muffled, resulting in reduced intelligibility of the recreated speech compared to, for example, a regular mobile to mobile call.

This is because the computer will encode a speech signal with a spectral emphasis that is different to the IRS specification due to the general purpose designed microphones headsets. However, the fixed/mobile phone receiving a call from the computer will treat the received signal as though it had been captured by another fixed/mobile phone.

It is an aim of some embodiments of the invention to address at least some of the problems associated with the prior art.

### SUMMARY

According to an aspect of the invention, there is provided a method of making a call in a packet switched network between a calling device and a called device, the method comprising receiving at a processor of the calling device samples of a speech signal and an identity of the called device, executing code on the processor to perform the steps of: determining based on the identity of the called device whether a filter should be applied to the samples, when it is determined that a filter should be applied, filtering the samples, and encoding the filtered samples for transmission on the packet switched network.

Filtering the samples may further comprise filtering the samples in accordance with a telephonic standard. The telephonic standard may comprise the P.48 “Specification for an intermediate reference system,” ITU-T Recommendation P.48, 1988 standard.

Filtering may be applied when it is determined that the called device comprises one of a mobile phone or a fixed phone. In particular, the filtering may be applied to the samples when it is determined based on the ID of the called receiver that the called receiver complies with the P.48 “Specification for an intermediate reference system,” ITU-T Recommendation P.48, 1988 standard.

The samples may be filtered in an adaptive filter. The method may further comprise adapting filter coefficients of the adaptive filter to match the frequency response of the filtered samples to a target frequency response.

Encoding the filtered samples may comprise encoding the filtered samples into a plurality of blocks, and wherein the method further comprises calculating an average power/magnitude spectra for the plurality of blocks to determine the frequency response of the filtered samples.

According to a further aspect of the invention, there is provided a terminal for making a call over a packet switched network to a called device, the terminal comprising a processor configured to receive digital samples of a speech signal and an identity of a called device, and a memory configured to store program code arranged so as when executed on the processor to: determine based on the identity of the called device whether a filter should be applied to the samples, when it is determined that the filter should be applied, filtering the samples, and encoding the filtered samples for transmission on the packet switched network.

According to a further aspect of the invention, there is provided a computer program product for making a call in a packet switched network between a calling device and a called device, the program comprising code arranged so as when executed on a processor to receive digital samples of a speech signal and an identity of the called device, determine based on the identity of the called device whether a filter should be applied to the samples, when it is determined that the filter should be applied, filtering the samples, and encoding the filtered samples for transmission on the packet switched network.

According to a further aspect of the invention, there is provided a communication system comprising a plurality of end-user terminals as described above.

### BRIEF DESCRIPTION OF THE DRAWINGS

For a better understanding of the present invention and to show how it may be carried into effect, reference will now be made by way of example to the accompanying drawings in which:

FIG. 1 shows the frequency characteristics of the Intermediate Reference System, sending side, according to ITU-T P.48,

FIG. 2 is a schematic block diagram of a VoIP network suitable for implementing embodiments of the invention,

FIG. 3 is a schematic block diagram of a VoIP client according to an embodiment of the invention,

FIG. 4 shows the frequency characteristics of a digital filter according to an embodiment of the invention,

FIG. 5 is a flow chart of a method according to an embodiment of the invention, and

FIG. 6 is a schematic block diagram of a VoIP client according to an embodiment of the invention.

### DETAILED DESCRIPTION OF PREFERRED EMBODIMENTS

Embodiments of the invention are described herein by way of particular examples and specifically with reference to exemplary embodiments. It will be understood by one skilled in the art that the invention is not limited to the details of the specific embodiments given herein.

Embodiments of the invention provide selective filtering of a speech signal in a VoIP device when placing a call to a mobile or fixed telephone to thereby alleviate the muffled quality of the speech reproduced at the receiver. According to embodiments, a digital filter is applied to a speech signal prior to the speech encoder inside the VoIP client.

FIG. 2 shows a schematic block diagram of a VoIP network 200 suitable for implementing embodiments of the invention. A VoIP client 202 is installed and run on a device coupled to a packet switched network 204, such as the internet. A gateway 206 is coupled to the packet switched network 204, and also to a circuit switched network 208, for example the public switched telephone network (PSTN). Telephone devices 210 and 212 are coupled to the circuit switched network 208, and may comprise landline telephones or mobile telephones.

The gateway 206 provides a connection between the packet switched network 204, as used for voice over IP telephony, and the circuit switched network 208 to allow a VoIP call originating at the VoIP client 202 to be routed to a traditional telephone 210, 212.

The destination of the VoIP call is determined in the VoIP client 202 based on an identity of a called party, allowing the call to be correctly routed over the packet switched network 204. If it is determined that the called party is a mobile or fixed telephone located in the circuit switched network 208, the encoded speech is transmitted to the gateway 206, where the speech is decoded and then transmitted over the circuit switched network 208 to the called party as a normal telephone call.

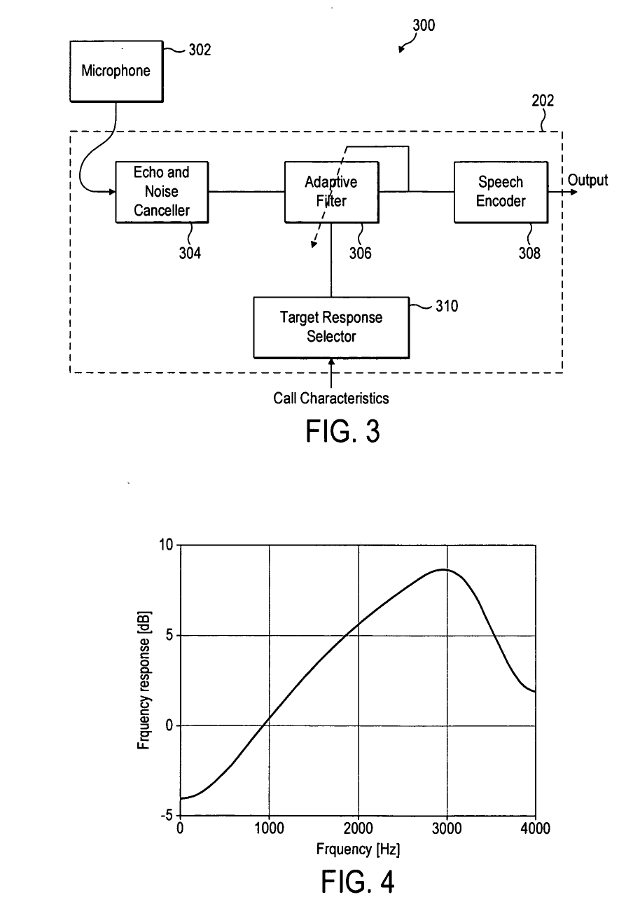

A block diagram of a VoIP device 300 for placing a call over a packet switched network 204 according to an embodiment of the invention is shown in FIG. 3. The VoIP device 300 comprises a microphone 302 coupled to a VoIP client 202.

The signal output by the microphone 302 is sampled in an analogue to digital converter, before being received by the VoIP client 202. The sampled microphone output is coupled to an echo and noise canceller 304. The echo and noise canceller 304 has an output coupled to an input of an adaptive filter 306. The adaptive filter 306 has an output coupled to an input of the speech encoder 308. The adaptive filter 306 receives filtered output samples in for use in adapting the filter coefficients. The speech encoder 308 outputs an encoded speech signal for transmission over the packet switched network 204.

A target response selector 310 receives information relating to call characteristics of a current call at an input, and has an output coupled to the adaptive filter 306 to provide a selected target frequency response to the adaptive filter 306.

In operation, a speech signal is captured by the microphone 302 and sampled in an analogue to digital converter (not shown), and the sampled signal is passed to the echo and noise canceller 304, which processes the captured speech signal to reduce echoes and unwanted noise components of the captured signal. The target frequency response 310 determines from the call characteristics information an appropriate target frequency response, this selected target frequency response is provided to the adaptive filter 306. The adaptive filter coefficients are then updated to match the desired target frequency response.

The target response selector 310 selects an appropriate target frequency response for a particular call scenario, based on the call characteristic information. For example, if it is determined that the call being placed is to a mobile phone, a target frequency response that emphasizes the frequency region where the second formant sits might be desirable in order to improve the speech intelligibility on the mobile side. In a further example scenario, the call characteristic may indicate that the call is a wideband call between two VoIP clients, and a target frequency response will then be chosen accordingly.

A block diagram of a VoIP device 600 for placing a call via a gateway 206 over a circuit switched network 208 according to an embodiment of the invention is shown in FIG. 6.

The VoIP device 600 is similar to that shown in FIG. 3, and comprises a microphone 302 coupled to a VoIP client 202. The signal output by the microphone 302 is sampled in an analogue to digital converter, before being received by the VoIP client 202. The sampled microphone output is coupled to an echo and noise canceller 304. The echo and noise canceller 304 has an output coupled to a switch 612. The switch couples the output of the echo and noise canceller to an input of a filter 306 in a first position, and in a second position couples the output of the echo and noise canceller to a bypass 614 that bypasses the filter 306 and connects the output of the echo and noise canceller to an input of the speech encoder 308. The filter 306 has an output coupled to an input of the speech encoder 308. The speech encoder 308 outputs an encoded speech signal for transmission over the packet switched network 204.

While the switch 612 is illustrated as a hardware switch, it will be understood that the switch could be implemented in software within the VoIP client 202.

A controller 610 is coupled to the switch to command the switch between the first and second positions. The controller 610 is further coupled to the filter 306 to allow control over the filter coefficients.

In operation, a speech signal is captured by the microphone 302 and sampled in an analogue to digital converter (not shown), and the sampled signal is passed to the echo and noise canceller 304, which processes the captured speech signal to reduce echoes and unwanted noise components of the captured signal. The controller 610 determines from the identity of the called party whether the receiver of the call is a mobile or fixed telephone, and if so controls the switch to the first position. With the switch in the first position, the speech signal is filtered in filter 306 before being encoded in the speech encoder 308.

If the controller 610 determines that the receiver of the call is not a telephonic device, for example the receiver may be a further VoIP client attached to the packet switched network 204, the switch is commanded to the second position, and the filter 306 is bypassed.

Thus, the filter 306 is only applied to the captured speech signal when it is determined that a call is to be connected between the VoIP client 202 and a mobile or fixed phone 210, 212. The filter 306 is not applied for a call between to VoIP clients communicating across the packet switched network 204.

In the embodiment of FIG. 6, the filter 306 may be adapted to mimic the IRS specification such that the filtered speech signal input to the speech encoder 308 conforms to the IRS specification. According to some embodiments, the filter 306 may be adapted to take into account the specific input device coupled to the VoIP client side, i.e. the filter coefficients may be adapted such that an average frequency response for the combination of all stages prior to the speech encoder, i.e. the microphone 302, echo and noise canceller 304, and filter 306, matches that of the target frequency response selected by the target response selector 310 according to some distortion measure.

The average frequency response for the combination of all stages prior to the speech encoder 308 may be calculated based on information provided by the speech encoder 308. For example, the speech encoder may be configured to provide information for each block of encoded speech that allows the calculation of an average power/magnitude spectra for the blocks of the encoded speech signal. This average power/magnitude spectra for the blocks of the encoded speech signal can be considered to be a product of the frequency response for the stages prior to the speech encoder with an average power spectrum of speech.

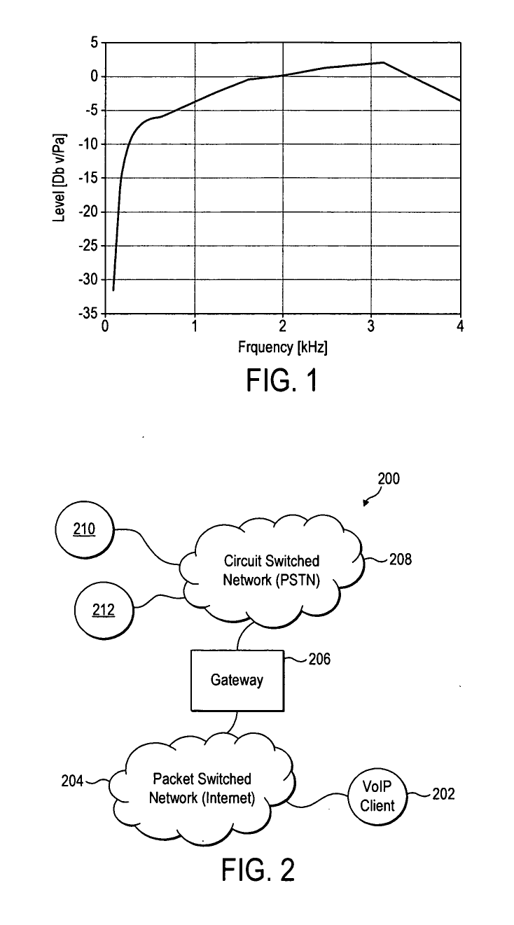

A target frequency response can then be determined as the product of an average power spectrum of voiced speech and the desired frequency response for the combination of all stages prior to the speech encoder including the filter 306, for example the power spectrum in FIG. 1.

The filter coefficients are then adapted based on a comparison of the calculated frequency response and the target frequency response.

According to the described embodiment of the invention, the filter 306 may comprise an Infinite Impulse Response (IIR) filter, i.e. having a transfer function defined by:

$$H ( z ) = \frac{{b}_{0} + {b}_{1} {z}^{- 1} + {b}_{2} {z}^{- 2} + {b}_{3} {z}^{- 3} + {b}_{4} {z}^{- 4}}{1 + {a}_{1} {z}^{- 1} + {a}_{2} {z}^{- 2} + {a}_{3} {z}^{- 3} + {a}_{4} {z}^{- 4}} ,$$

where the filter coefficients aₙ and bₙ are subject to tuning.

FIG. 4 shows an example frequency response of the adaptive filter 306 according to one embodiment. The filter 306 is applied prior to the speech encoder 308 in the VoIP client 202 and is only active for calls to mobile and fixed phones.

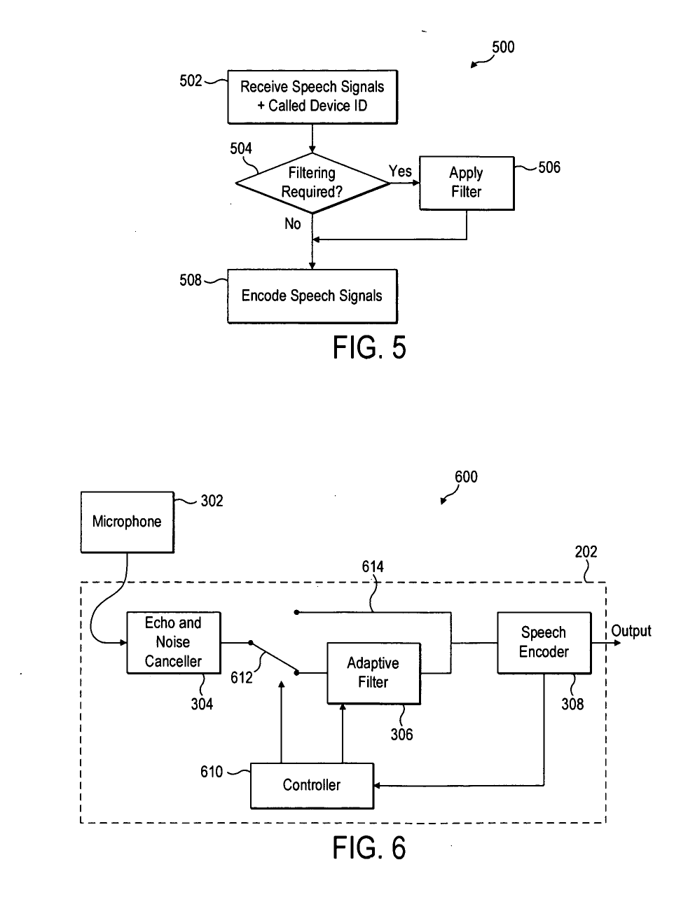

FIG. 5 shows a method 500 according to an embodiment of the invention. At block 502, speech signals are received, along with a call characteristic comprising an identity of a called device to which the speech signals are to be communicated. In step 504, a target frequency response is determined based on the identity of the called device. For example, if the called device is determined to be a fixed/mobile telephone a target frequency response matching the IRS specification may be selected. Finally, the speech signals are encoded in step 508.

Embodiments of the invention provide for filtering of the speech signal prior to the signal being encoded, for example to give spectral emphasis to the frequency region ˜1-4 kHz, the second formant frequencies, when placing a call to a mobile or fixed telephone. This filtering alleviates the muffled quality experienced when placing a call from a VoIP client using a general purpose microphone to a fixed/mobile phone, thereby improving speech intelligibility at the receiving side.

Advantageously, adaptation of the filter coefficients to match the average frequency response of the microphone 302, echo and noise canceller 304, and filter 306 to a desired target frequency response allows the VoIP client 202 to adapt to variations in frequency response of different input devices, and thus produce a more consistent audio quality at the receiving side.

The modules of the VoIP client 202 are implemented in software, such that each of the components 304 to 308 comprise modules of software stored on one or more memory devices and executed on a processor.

Embodiments of the invention have been described in the context of the ITU-T P.48 Intermediate Reference System as one example target frequency response that is appropriate for calls having certain characteristics. However, the design is by no means limited to match the IRS specification, and it would be understood that other target frequency responses might yield even better speech intelligibility.

It will be appreciated that the above embodiments are described only by way of example. For instance, some or all of the modules of the VoIP client could be implemented in dedicated hardware units. Further, instead of a user input device like a microphone, the input speech signal could be received from some other source such as a storage device. Similarly, echo and noise canceller 304 may be omitted, or further processing blocks may be included in the VoIP client 202. The filter 306 may be adapted to match an average frequency response for the combination of all stages prior to the speech encoder, including the further processing blocks, to the target frequency response.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method of making a call in a packet switched network between a calling device and a called device, the method comprising:
receiving at a processor of the calling device samples of a speech signal and an identity of the called device;
executing code on the processor to perform the steps of:
determining based on the identity of the called device whether a filter should be applied to the samples;
when it is determined that a filter should be applied, filtering the samples; and
encoding the filtered samples for transmission on the packet switched network.

2. The method of claim 1, wherein filtering the samples further comprises filtering the samples in accordance with a telephonic standard.

3. The method of claim 2, wherein the telephonic standard comprises the P.48 “Specification for an intermediate reference system,” ITU-T Recommendation P.48, 1988 standard.

4. The method of claim 1, wherein the filtering is applied if it is determined that the called device comprises one of a mobile phone or a fixed phone.

5. The method of claim 1, wherein filtering is applied to the samples when it is determined based on the ID of the called receiver that the called receiver complies with the P.48 “Specification for an intermediate reference system,” ITU-T Recommendation P.48, 1988 standard.

6. The method of claim 1, wherein filtering the samples comprises filtering the samples in an adaptive filter.

7. The method of claim 6, further comprising adapting filter coefficients of the adaptive filter to match the frequency response of the filtered samples to a target frequency response.

8. The method of claim 7, wherein encoding the filtered samples comprises encoding the filtered samples into a plurality of blocks, and wherein the method further comprises calculating an average power/magnitude spectra for the plurality of blocks to determine the frequency response of the filtered samples.

9. A terminal for making a call over a packet switched network to a called device, the terminal comprising:
a processor configured to receive digital samples of a speech signal and an identity of a called device, and
a memory configured to store program code arranged so as when executed on the processor to:
determine based on the identity of the called device whether a filter should be applied to the samples;
when it is determined that the filter should be applied, filtering the samples; and
encoding the filtered samples for transmission on the packet switched network.

10. The terminal of claim 9, wherein the program code is further arranged so as when executed on the processor to filter the samples in accordance with a telephonic standard.

11. The terminal of claim 10, wherein the telephonic standard comprises the P.48 “Specification for an intermediate reference system,” ITU-T Recommendation P.48, 1988 standard.

12. The terminal of claim 9, wherein the program code is further arranged so as when executed on the processor to apply the filtering when it is determined that the called device comprises one of a mobile phone or a fixed phone.

13. The terminal of claim 9 wherein the program code is further arranged so as when executed on the processor to apply filtering to the samples when it is determined based on the identity of the called receiver that the called receiver complies with the P.48 “Specification for an intermediate reference system,” ITU-T Recommendation P.48, 1988 standard.

14. The terminal of claim 9, wherein the program code is further arranged so as when executed on the processor to filter the samples in an adaptive filter.

15. The terminal of claim 14, wherein the program code is further arranged so as when executed on the processor to adapt the coefficients of the adaptive filter to match the frequency response of the filtered samples to a target frequency response.

16. The terminal of claim 15, wherein the program code is further arranged so as when executed on the processor to encode the filtered samples into a plurality of blocks, and to calculate an average power/magnitude spectra for the plurality of blocks to determine the frequency response of the filtered samples.

17. A computer program product for making a call in a packet switched network between a calling device and a called device, the program comprising code arranged so as when executed on a processor to:
receive digital samples of a speech signal and an identity of the called device;
determine based on the identity of the called device whether a filter should be applied to the samples;
when it is determined that the filter should be applied, filtering the samples; and
encoding the filtered samples for transmission on the packet switched network.

18. The computer program product of claim 17, wherein the program code is further arranged so as when executed on a processor to filter the samples in accordance with a telephonic standard.

19. A communication system comprising a plurality of end-user terminals according to claim 9.

20. A method of making a call in a packet switched network between a called device and a calling device, the method comprising;
receiving at a processor of the calling device samples of a speech signal;
executing code on the processor to perform the steps of:
determining a call characteristic for the call;
selecting a target frequency response based on the call characteristic information;
adapting filter coefficients of an adaptive filter to match the target frequency response;
filtering the samples in the adaptive filter; and
encoding the filtered samples for transmission on the packet switched network.

21. A terminal for making a call over a packet switched network to a called device, the terminal comprising:
a processor configured to receive digital samples of a speech signal and an identity of a called device, and
a memory configured to store program code arranged so as when executed on the processor to:
determining a call characteristic for the call;
selecting a target frequency response based on the call characteristic information;
adapting filter coefficients of an adaptive filter to match the target frequency response;
filtering the samples in the adaptive filter; and
encoding the filtered samples for transmission on the packet switched network.
